(19) United States
(12) Patent Application Publication
(10) Pub. No.: US 2016/0196783 A1
(43) Pub. Date: Jul. 7, 2016

(54) PIXEL DRIVE CIRCUIT, ARRAY SUBSTRATE, DISPLAY DEVICE AND PIXEL DRIVE METHOD

(71) Applicants: BOE TECHNOLOGY GROUP CO., LTD., Beijing (CN); HEFEI BOE OPTOELECTRONICS TECHNOLOGY CO., LTD., Anhui (CN)

(72) Inventors: Zuquan HU, Beijing (CN); Weigang GONG, Beijing (CN)

(21) Appl. No.: 14/917,827

(22) PCT Filed: May 29, 2014
(86) PCT No.: PCT/CN2014/078778

§ 371 Date: Mar. 9, 2016

(30) Foreign Application Priority Data
Dec. 27, 2013 (CN) 201310746150.2

(51) Int. Cl. G09G 3/32

(52) U.S. Cl. CPC G09G 3/3258; G09G 3/3291; G09G 2320/0646; G09G 2310/0202; G09G 2300/0809; G09G 2320/0233

(57) ABSTRACT

The present invention discloses a pixel drive circuit, an array substrate, a display device and a pixel drive method. The pixel drive circuit may include a drive unit, a switch unit, a threshold voltage compensation module and a light-emitting device, the threshold voltage compensation module is connected to a scan signal line, a first control line, a second control line, a second power supply and the switch unit, respectively, the light-emitting device is connected to the second power supply and the threshold voltage compensation module, respectively, the drive unit is connected to a first power supply and the threshold voltage compensation module, respectively, and the switch unit is connected to the scan signal line and a data signal line, respectively; and the threshold voltage compensation module includes a threshold voltage holding unit, an anti-interference unit, an auxiliary gating unit and a charge-and-discharge control switch unit.

### FIELD OF THE INVENTION

The present invention relates to the field of display technology, in particular to a pixel drive circuit, an array substrate, a display device and a pixel drive method

### BACKGROUND OF THE INVENTION

With the development of display technology, more and more active matrix organic light emitting diode (AMOLED for short) display devices have come into the market. Compared with conventional thin film transistor liquid crystal displays (TFT LCDs for short), AMOLED display devices have quicker response, higher contrast ratio and wider visual angle, and are thus preferred by more and more panel manufacturer.

FIG. 1 is a schematic structural diagram of an AMOLED pixel drive circuit in the prior art. As shown in FIG. 1, the pixel drive circuit includes a first thin film transistor (TFT for short) T1, a second TFT T2, a capacitor C and an organic light-emitting diode (OLED for short). The gate of the second TFT T2 is connected to a scan signal line that supplies a scan voltage of Vscan.

The drain of the second TFT T2 is connected to a data signal line that supplies a data voltage of Vdata. The source of the second TFT T2 is connected to the gate of the first TFT T1. The drain of the first TFT T1 is connected to the cathode of the OLED, and the source of the first TFT T1 is connected to a first power supply. A first supply voltage Vss provided by the first power supply is at a low level. Two terminals of the capacitor C are connected to the gate and source of the first TFT T1, respectively. The anode of the OLED is connected to a second power supply that provides a second supply voltage VDD at a high level. FIG. 2 is a timing diagram of the AMOLED pixel drive circuit in FIG. 1. As shown in FIG. 2, during the time period of t1, Vscan is at a high level to turn on the second TFT T2, and at this time, Vdata is transferred to the capacitor C and the gate of the first TFT T1 by the data signal line to turn on the first TFT T1, so that the cathode of the OLED is connected to the first supply voltage Vss and starts to work and emits light. During the time period of t2, Vscan is at a low level to turn off the second TFT T2, at this time, due to the charge retention effect of the capacitor C, the gate of the first TFT T1 remains at a high level, the first TFT T1 remains on-state, OLED keeps on working until the time when Vscan becomes at a high level, and light-emitting state of the OLED may change with the data voltage Vdata. It can be known from the above that, supply of the data voltage Vdata is controlled by the second TFT T2, and working state of the OLED is controlled by the first TFT T1. Therefore, in general, the second TFT T2 is referred to as switch TFT, and the first TFT T1 is referred to as drive TFT. The capacitor mainly plays a role of maintaining voltage.

In the AMOLED pixel drive circuit provided in the prior art, the threshold voltage of the first TFT T1 may vary with process variation and change in temperature of a display device during its working process. In addition, after the first TFT T1 is turned on, the working current of the OLED is related to the threshold voltage of the first TFT T1, and the light-emitting brightness of the OLED is quite sensitive to the change in its working current. Therefore, the change in the threshold voltage of the first TFT T1 may cause a great change in the light-emitting brightness of the OLED, which results in non-uniform light-emitting brightness of the display device.

### SUMMARY OF THE INVENTION

The present invention provides a pixel drive circuit, an array substrate, a display device and a pixel drive method, in order to allow light-emitting brightness of a light-emitting device to be uniform, thereby improving uniformity of light-emitting brightness of a display device.

To achieve the above object, the present invention provides a pixel drive circuit, which includes a drive unit, a switch unit, a threshold voltage compensation module and a light-emitting device, the threshold voltage compensation module is connected to a scan signal line, a first control line, a second control line, a second power supply and the switch unit, respectively, the light-emitting device is connected to the second power supply and the threshold voltage compensation module, respectively, the drive unit is connected to a first power supply and the threshold voltage compensation module, respectively, and the switch unit is connected to the scan signal line and a data signal line, respectively; and the threshold voltage compensation module includes a threshold voltage holding unit, an anti-interference unit, an auxiliary gating unit and a charge-and-discharge control switch unit.

Optionally, the threshold voltage holding unit includes a capacitor, the anti-interference unit includes a third switch tube, the auxiliary gating unit includes a fourth switch tube, and the charge-and-discharge control switch unit includes a fifth switch tube;

a control electrode of the third switch tube is connected to the scan signal line, a first electrode of the third switch tube is connected to the second power supply and a first electrode of the light-emitting device, and a second electrode of the third switch tube is connected to a second electrode of the light-emitting device;

a control electrode of the fourth switch tube is connected to the first control line, a first electrode of the fourth switch tube is connected to the second electrode of the light-emitting device and the second electrode of the third switch tube, and a second electrode of the fourth switch tube is connected to a first electrode of the fifth switch tube and the drive unit;

a control electrode of the fifth switch tube is connected to the second control line, a second electrode of the fifth switch tube is connected to a second terminal of the capacitor and the drive unit; and

the first electrode of the light-emitting device is connected to the second power supply.

Optionally, the drive unit includes a first switch tube, and the switch unit includes a second switch tube;

a control electrode of the first switch tube is connected to the second electrode of the fifth switch tube and the second terminal of the capacitor, a first electrode of the first switch tube is connected to the second electrode of the fourth switch tube and the first electrode of the fifth switch tube, and a second electrode of the first switch tube is connected to the first power supply; and

a control electrode of the second switch tube is connected to the scan signal line, a first electrode of the second switch tube is connected to the data signal line, and a second electrode of the second switch tube is connected to a first terminal of the capacitor.

Optionally, working current I of the light-emitting device is equal to K(VH−VL)², where K is a process constant, VH is a high level of a data voltage provided by the data signal line, and VL is a low level of a data voltage provided by the data signal line.

Optionally, the first switch tube, the second switch tube, the third switch tube, the fourth switch tube and the fifth switch tube are all thin film transistors.

To achieve the above object, the present invention provides an array substrate, which includes the above pixel drive circuit.

To achieve the above object, the present invention provides a display device, which includes the above array substrate.

To achieve the above object, the present invention provides a pixel drive method based on the above pixel drive circuit; and

the method includes:

a charging step, in which the switch unit is turned on, the data signal line provides a low level, and the anti-interference unit, the auxiliary gating unit and the charge-and-discharge control switch unit control the second power supply to charge the threshold voltage holding unit;

a discharging step, in which the charge-and-discharge control switch unit, the drive unit and the threshold voltage holding unit form a discharge loop;

a voltage-adjusting step, in which the switch unit is turned on, the data signal line provides a high level, and voltage at the control electrode of the drive unit is adjusted through the threshold voltage holding unit to turn on the drive unit; and

a driving step, in which the switch unit is turned off, and the drive unit remains on-state under the action of the threshold voltage holding unit and drives the light-emitting device to emit light.

Optionally, the pixel drive circuit adopts the above-described pixel drive circuit; and

the charging step includes: turning on the second switch tube and the third switch tube under the control of a scan voltage provided by the scan signal line, turning on the fourth switch tube under the control of a first control voltage provided by the first control line, turning on the fifth switch tube under the control of a second control voltage provided by the second control line, and supplying the data signal line with a low level, so that the second power supply charges the capacitor;

the discharging step includes: turning on the second switch tube and the third switch tube under the control of the scan voltage provided by the scan signal line, turning off the fourth switch tube under the control of the first control voltage provided by the first control line, and turning on the fifth switch tube under the control of the second control voltage provided by the second control line, so that the fifth switch tube, the first switch tube and the capacitor form a discharge loop;

the voltage-adjusting step includes: turning on the second switch tube and the third switch tube under the control of the scan voltage provided by the scan signal line, turning off the fourth switch tube under the control of the first control voltage provided by the first control line, turning off the fifth switch tube under the control of the second control voltage provided by the second control line, supplying the data signal line with a high level, and adjusting the voltage at the control electrode of the first switch tube through the capacitor to turn on the first switch tube; and

the driving step includes: turning off the second switch tube and the third switch tube under the control of the scan voltage provided by the scan signal line, turning on the fourth switch tube under the control of the first control voltage provided by the first control line, turning off the fifth switch tube under the control of the second control voltage provided by the second control line, and keeping the first switch tube in on-state under the action of the capacitor and driving the light-emitting device to emit light.

Optionally, in the charging step, the scan voltage is at a high level, the first control voltage is at a high level, and the second control voltage is at a high level;

in the discharging step, the scan voltage is at a high level, the first control voltage is at a low level, and the second control voltage is at a high level;

in the voltage-adjusting step, the scan voltage is at a high level, the first control voltage is at a low level, and the second control voltage is at a low level; and

in the driving step, the scan voltage is at a low level, the first control voltage is at a high level, and the second control voltage is at a low level.

The present invention has the beneficial advantages as follows:

In the technical solutions of the pixel drive circuit, array substrate, display device and pixel drive method provided by the present invention, the pixel drive circuit includes a drive unit, a switch unit, a threshold voltage compensation module and a light-emitting device, the threshold voltage compensation module is connected to a scan signal line, a first control line, a second control line, a second power supply and the switch unit, respectively, the light-emitting device is connected to the second power supply and the threshold voltage compensation module, respectively, the drive unit is connected to a first power supply and the threshold voltage compensation module, respectively, and the switch unit is connected to the scan signal line and a data signal line, respectively. The pixel drive circuit of the present invention allows the working current of the light-emitting device to be dependent of the threshold voltage of the drive unit, so that the light-emitting brightness of the light-emitting device is uniform, and uniformity of the light-emitting brightness of the display device is thus improved.

### BRIEF DESCRIPTION OF THE DRAWINGS

FIG. 1 is a schematic structural diagram of an AMOLED pixel drive circuit in the prior art;

FIG. 2 is a timing diagram of the AMOLED pixel drive circuit in FIG. 1;

FIG. 3 is a schematic structural diagram of a pixel drive circuit provided by a first embodiment of the present invention;

FIG. 4 is a timing diagram of the pixel drive circuit in FIG. 3; and

FIG. 5 is a flowchart of a pixel drive method provided by a fourth embodiment of the present invention.

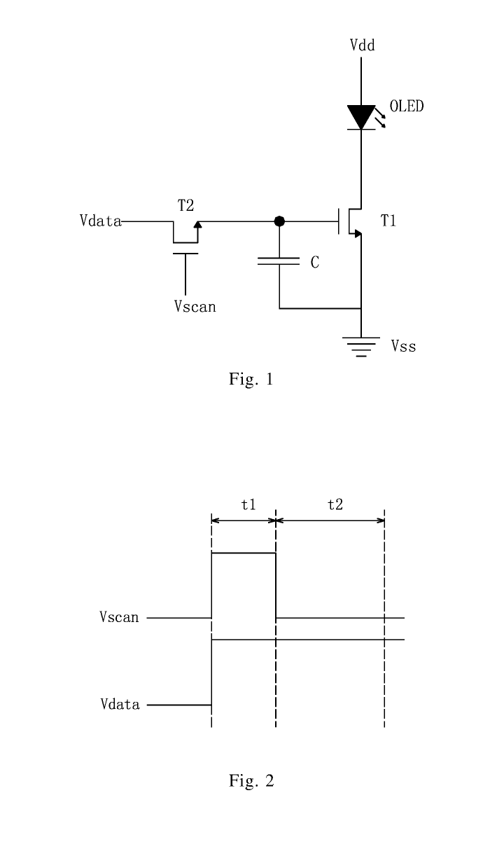

### DESCRIPTION OF THE PREFERRED EMBODIMENT

To enable those skilled in the art to better understand the technical solutions of the present invention, a pixel drive circuit, an array substrate, a display device and a pixel drive method provided by the present invention will be described, by way of examples, in detail below in conjunction with the accompanying drawings.

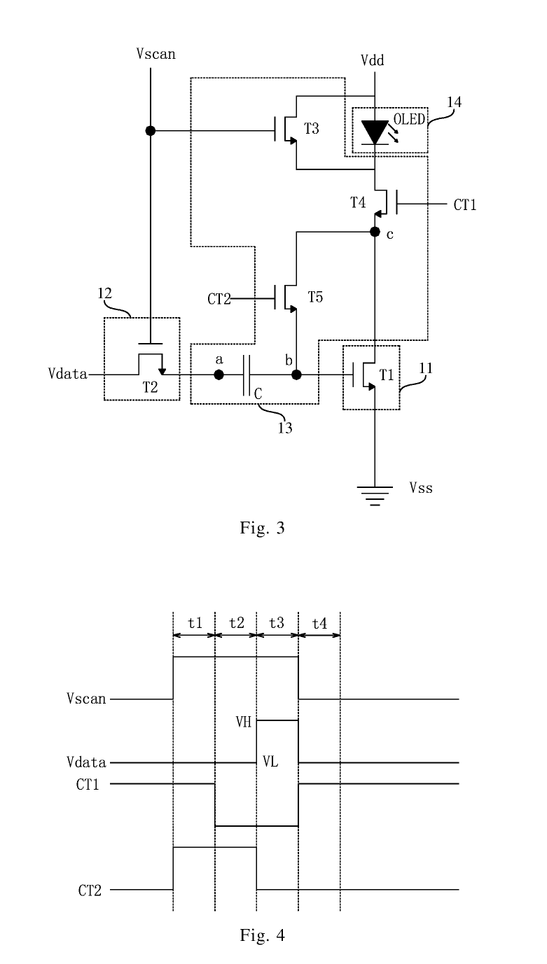

FIG. 3 is a schematic structural diagram of a pixel drive circuit provided by a first embodiment of the present invention. As shown in FIG. 3, the pixel drive circuit includes: a drive unit 11, a switch unit 12, a threshold voltage compensation module 13 and a light-emitting device 14. The threshold voltage compensation module 13 is connected to a scan signal line, a first control line CT1, a second control line CT2, a second power supply and the switch unit 12, respectively. The light-emitting device 14 is connected to the second power supply and the threshold voltage compensation module 13, respectively. The drive unit 11 is connected to a first power supply and the threshold voltage compensation module 13, respectively. The switch unit 12 is connected to the scan signal line and a data signal line, respectively.

The threshold voltage compensation module 13 may include a threshold voltage holding unit, an anti-interference unit, an auxiliary gating unit and a charge-and-discharge control switch unit. The threshold voltage holding unit, the charge-and-discharge control switch unit, the auxiliary gating unit and the anti-interference unit may be sequentially connected. That is, the threshold voltage holding unit is connected to the charge-and-discharge control switch unit, the charge-and-discharge control switch unit is connected to the threshold voltage holding unit and the auxiliary gating unit, and the auxiliary gating unit is connected to the charge-and-discharge control switch unit and the anti-interference unit.

In the embodiment, the first control line CT1 is applied with a first control voltage, the second control line CT2 is applied with a second control voltage, the first power supply provides a first supply voltage Vss, the second power supply provides a second supply voltage Vdd, the data signal line is applied with a data voltage Vdata, and the scan signal line is applied with a scan voltage Vscan.

In the embodiment, the drive unit 11 may include a first switch tube T1, the switch unit 12 may include a second switch tube T2, the threshold voltage holding unit may include a capacitor C, the anti-interference unit may include a third switch tube T3, the auxiliary gating unit may include a fourth switch tube T4, and the charge-and-discharge control switch unit may include a fifth switch tube T5.

The control electrode of the first switch tube T1 is connected to a second electrode of the fifth switch tube T5 and a second terminal of the capacitor C at point b. A first electrode of the first switch tube T1 is connected to a second electrode of the fourth switch tube T4 and a first electrode of the fifth switch tube T5 at point c. A second electrode of the first switch tube T1 is connected to the first power supply providing the first supply voltage Vss.

The control electrode of the second switch tube T2 is connected to the scan signal line applied with the scan voltage Vscan. A first electrode of the second switch tube T2 is connected to the data signal line applied with the data voltage Vdata. A second electrode of the second switch tube T2 is connected to a first terminal of the capacitor C at point a.

The control electrode of the third switch tube T3 is connected to the scan signal line. A first electrode of the third switch tube T3 is connected to the second power supply providing the second supply voltage Vdd and a first electrode of the light-emitting device 14. A second electrode of the third switch tube T3 is connected to a first electrode the fourth switch tube T4 and a second electrode of the light-emitting device 14. Therefore, the third switch tube T3 and the light-emitting device 14 are connected in parallel.

The control electrode of the fourth switch tube T4 is connected to the first control line CT1. The first electrode of the fourth switch tube T4 is connected to the second electrode of the light-emitting device 14 and the second electrode of the third switch tube T3. The second electrode of the fourth switch tube T4 is connected, at point c, to the first electrode of the fifth switch tube T5 and the drive unit 11 (specifically, the first electrode of the first switch tube T1 in the embodiment).

The control electrode of the fifth switch tube T5 is connected to the second control line CT2. The first electrode of the fifth switch tube T5 is connected, at point c, is connected to the second electrode of the fourth switch tube T4 and the drive unit 11 (specifically, the first electrode of the first switch tube T1 in the embodiment). The second electrode of the fifth switch tube T5 is connected, at point b, to the second terminal of the capacitor C and the control electrode of the first switch tube T1.

FIG. 4 is a timing diagram of the pixel drive circuit in FIG. 3. Working process of the pixel drive circuit in the embodiment is described in detail below with reference to FIGS. 3 and 4.

In a charging stage, the switch unit 12 is turned on, the data signal line provides a low level, and the anti-interference unit, the auxiliary gating unit and the charge-and-discharge control switch unit control the second power supply to charge the threshold voltage holding unit. Specifically, in the charging stage, the second switch tube T2 and the third switch tube T3 are turned on under the control of the scan voltage Vscan provided by the scan signal line, the fourth switch tube T4 is turned on under the control of the first control voltage provided by the first control line CT1, the fifth switch tube T5 is turned on under the control of the second control voltage provided by the second control line CT2, and the data signal line provides a low level, so that the second power supply charges the capacitor C. More specifically, the charging stage is the time period of t1, during the time period of t1, the scan voltage Vscan provided by the scan signal line is at a high level to turn on the second switch tube T2 and the third switch tube T3, the first control voltage provided by the first control line CT1 is at a high level to turn on the fourth switch tube T4, and the second control voltage provided by the second control line CT2 is at a high level to turn on the fifth switch tube T5. Since the third switch tube T3 is turned on to short-circuit the light-emitting device 14, the light-emitting device 14 does not work. Because the fourth switch tube T4 and the fifth switch tube T5 are turned on, the second supply voltage Vdd provided by the second power supply is transferred to the control electrode of the first switch tube T1 via the fourth switch tube T4 and the fifth switch tube T5 in on-state, and charges the capacitor C, and at this time, Vb=Vc=Vdd. Because the second switch tube T2 is turned on, the data voltage Vdata provided by the data signal line is transferred to point a at the terminal of the capacitor C, and at this time, Va=Vdata.

In a discharging stage, the charge-and-discharge control switch unit, the drive unit 11 and the threshold voltage holding unit form a discharge loop. Specifically, in the discharging stage, the second switch tube T2 and the third switch tube T3 are turned on under the control of the scan voltage Vscan provided by the scan signal line, the fourth switch tube T4 is turned off under the control of the first control voltage provided by the first control line CT1, and the fifth switch tube T5 is turned on under the control of the second control voltage provided by the second control line CT2, so that the fifth switch tube T5, the first switch tube T1 and the capacitor C form a discharge loop. More specifically, the discharging stage is the time period of t2, during the time period of t2, the scan voltage Vscan provided by the scan signal line is at a high level to turn on the second switch tube T2 and the third switch tube T3, the first control voltage provided by the first control line CT1 is at a low level to turn off the fourth switch tube T4, and the second control voltage provided by the second control line CT2 is at a high level to turn on the fifth switch tube T5. The third switch tube T3 is turned on, the fourth switch tube T4 is turned off and the fifth switch tube T5 is turned on, so the light-emitting device 14 is short-circuited, therefore, the light-emitting device 14 still does not work and the first electrode of the fifth switch tube T5 is disconnected from the second power supply. At this time, the fifth switch tube T5, the first switch tube T1 and the capacitor C form a discharge loop. Therefore, the capacitor C discharges until the voltage at the control electrode of the first switch tube T1 (i.e., voltage Vb at point b) drops to Vth+Vss, and at this time, the first switch tube T1 is in a critical conduction state, and will be turned off if the discharge loop keeps on discharging. Because the second switch tube T2 remains on-state, and the data voltage Vdata provided by the data signal line is at a low level VL, the voltage Va at the first terminal (point a) of the capacitor C satisfies: Va=Vdata=VL, the voltage Vb at the second terminal (point b) of the capacitor C is equal to Vth+Vss, and then the voltage difference Vab across the two terminals of the capacitor C satisfies: Vab=Va−Vb=VL−(Vth+Vss), where Vth is the threshold voltage of the first switch tube T1.

In a voltage-adjusting stage, the switch unit 12 is turned on, the data signal line provides a high level, and voltage at the control electrode of the drive unit 11 is adjusted through the threshold voltage holding unit to turn on the drive unit 11. Specifically, in the voltage-adjusting stage, the second switch tube T2 and the third switch tube T3 are turned on under the control of the scan voltage Vscan provided by the scan signal line, the fourth switch tube T4 is turned off under the control of the first control voltage provided by the first control line CT1, the fifth switch tube T5 is turned off under the control of the second control voltage provided by the second control line CT2, and the data signal line provides a high level, so that the voltage at the control electrode of the first switch tube T1 is adjusted through the capacitor C to turn on the first switch tube T1. More specifically, the voltage-adjusting stage is the time period of t3, during the time period of t3, the scan voltage Vscan provided by the scan signal line is at a high level to turn on the second switch tube T2 and the third switch tube T3, the first control voltage provided by the first control line CT1 is at a low level to turn off the fourth switch tube T4, and the second control voltage provided by the second control line CT2 is at a low level to turn off the fifth switch tube T5. Because the third switch tube T3 is turned on to short-circuit the light-emitting device 14, the light-emitting device 14 still does not work. As both the fourth switch tube T4 and the fifth switch tube T5 are turned off, the second terminal (point b) of the capacitor C is floating. As the second switch tube T2 is turned on and the data voltage Vdata provided by the data signal line is at a high level VH, the data voltage Vdata provided by the data signal line is transferred to the first terminal (point a) of the capacitor C, and at this point, Va=Vdata=VH. As the second terminal (point b) of the capacitor C is floating, it can be known from law of charge conservation, the voltage difference across the two terminals of the capacitor C at this time remains the same as that during the time period of t2, therefore, Vb=Va−Vab=VH−Vab=VH−VL+(Vth+Vss), and the first switch tube T1 is thus turned on.

In a driving stage, the switch unit 12 is turned off, and the drive unit 11 remains on-state under the action of the threshold voltage holding unit and drives the light-emitting device 14 to emit light. Specifically, in the driving stage, the second switch tube T2 and the third switch tube T3 are turned off under the control of the scan voltage Vscan provided by the scan signal line, the fourth switch tube T4 is turned on under the control of the first control voltage provided by the first control line CT1, and the fifth switch tube T5 is turned off under the control of the second control voltage provided by the second control line CT2, so that the first switch tube 1 remains on-state under the action of the capacitor C and drives the light-emitting device 14 to emit light. More specifically, the driving stage is the time period of t4, during the time period of t4, the scan voltage Vscan provided by the scan signal line is at a low level to turn off the second switch tube T2 and the third switch tube T3, the first control voltage provided by the first control line CT1 is at a high level to turn on the fourth switch tube T4, and the second control voltage provided by the second control line CT2 is at a low level to turn off the fifth switch tube T5. Due to the maintaining effect of the capacitor C, the voltage at the second terminal (point b) of the capacitor C remains unchanged, that is, the voltage Vb at the second terminal (point b) of the capacitor C is equal to VH-VL+(Vth+Vss), and thus the first switch tube T1 is in an on-state. At this time, current flowing through the first switch tube T1 is the working current of the light-emitting device 14. The working current I of the light-emitting device 14 is equal to K(Vgs−Vth)², where Vgs is the gate-source voltage of the first switch tube T1, and K is a process constant, which is a constant related to process parameters and physical dimension of the first switch tube T1. Since Vgs=Vb−Vss=VH−VL+(Vth+Vss)−Vss=VH−VL+Vth, the working current I=K(Vgs−Vth)²=K(VH−VL+Vth−Vth)²=K(VH−VL)². It can be known from the foregoing formula of the working current of the light-emitting device 14 that, the working current of the light-emitting device 14 is independent of the threshold voltage Vth of the first switch tube T1.

In the subsequent time period, the first switch tube T1 remains on-state and the light-emitting device 14 remains in a light-emitting state, until the scan voltage Vscan is changed into a high level in the next period of time. In the embodiment, the first switch tube T1, the second switch tube T2, the third switch tube T3, the fourth switch tube T4 and the fifth switch tube T5 are all thin film transistors. The control electrode may be gate, the first electrode may be drain or source, and accordingly, the second electrode may be source or drain.

In the embodiment, the light-emitting device 14 is an OLED.

Preferably, the pixel drive circuit in the embodiment is an AMOLED pixel drive circuit.

The pixel drive circuit provided by the embodiment includes a drive unit, a switch unit, a threshold voltage compensation module and a light-emitting device; the threshold voltage compensation module is connected to a scan signal line, a first control line, a second control line, a second power supply and the switch unit, respectively, the light-emitting device is connected to the second power supply and the threshold voltage compensation module, respectively, the drive unit is connected to a first power supply and the threshold voltage compensation module, respectively, and the switch unit is connected to the scan signal line and a data signal line, respectively. The pixel drive circuit of the present invention allows working current of the light-emitting device to be independent of the threshold voltage of the drive unit, so that the light-emitting brightness of the light-emitting device is uniform, and uniformity of the light-emitting brightness of the display device is thus improved. The pixel drive circuit provided by the embodiment includes fewer thin film transistors and one capacitor C, thus has a simple structure and can be easily implemented.

A second embodiment of the present invention provides an array substrate including a pixel drive circuit, which may be the pixel drive circuit in the first embodiment.

Preferably, the array substrate in the embodiment is an AMOLED array substrate.

In the array substrate provided by the embodiment, the pixel drive circuit includes a drive unit, a switch unit, a threshold voltage compensation module and a light-emitting device; the threshold voltage compensation module is connected to a scan signal line, a first control line, a second control line, a second power supply and the switch unit, respectively, the light-emitting device is connected to the second power supply and the threshold voltage compensation module, respectively, the drive unit is connected to a first power supply and the threshold voltage compensation module, respectively, and the switch unit is connected to the scan signal line and a data signal line, respectively. The pixel drive circuit of the present invention allows working current of the light-emitting device to be independent of the threshold voltage of the drive unit, so that the light-emitting brightness of the light-emitting device is uniform, and uniformity of the light-emitting brightness of the display device is thus improved.

A third embodiment of the present invention provides a display device including an array substrate, which may be the array substrate in the second embodiment.

Preferably, the display device in the embodiment is an AMOLED display device.

In the display device provided by the embodiment, the pixel drive circuit includes a drive unit, a switch unit, a threshold voltage compensation module and a light-emitting device; the threshold voltage compensation module is connected to a scan signal line, a first control line, a second control line, a second power supply and the switch unit, respectively, the light-emitting device is connected to the second power supply and the threshold voltage compensation module, respectively, the drive unit is connected to a first power supply and the threshold voltage compensation module, respectively, and the switch unit is connected to the scan signal line and a data signal line, respectively. The pixel drive circuit of the present invention allows working current of the light-emitting device to be independent of the threshold voltage of the drive unit, so that the light-emitting brightness of the light-emitting device is uniform, and uniformity of the light-emitting brightness of the display device is thus improved.

A fourth embodiment of the present invention provides a pixel drive method based on a pixel drive circuit, and the pixel drive circuit includes a drive unit, a switch unit, a light-emitting device and a threshold voltage compensation module, the threshold voltage compensation module is connected to a scan signal line, a first control line, a second control line, a second power supply and the switch unit, respectively, the light-emitting device is connected to the second power supply and the threshold voltage compensation module, respectively, the drive unit is connected to a first power supply and the threshold voltage compensation module, respectively, and the switch unit is connected to the scan signal line and a data signal line, respectively.

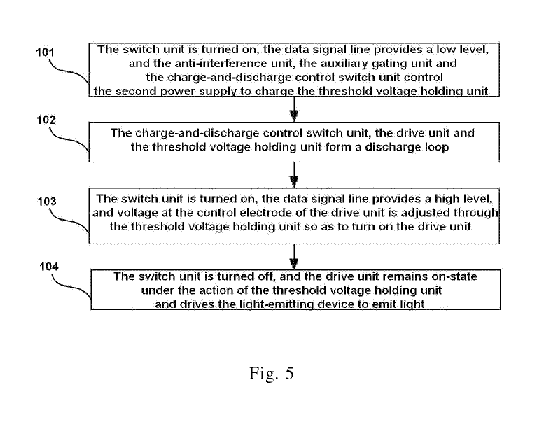

FIG. 5 is a flowchart of a pixel drive method provided by a fourth embodiment of the present invention, and as shown in FIG. 5, the pixel drive method includes steps as follows.

At step 101 (charging step): the switch unit is turned on, the data signal line provides a low level, and an anti-interference unit, an auxiliary gating unit and a charge-and-discharge control switch unit in the threshold voltage compensation module control the second power supply to charge the threshold voltage holding unit.

At step 102 (discharging step), the charge-and-discharge control switch unit, the drive unit and the threshold voltage holding unit form a discharge loop.

At step 103 (voltage-adjusting step), the switch unit is turned on, the data signal line provides a high level, and voltage at the control electrode of the drive unit is adjusted through the threshold voltage holding unit so as to turn on the drive unit.

At step 104 (driving step), the switch unit is turned off, and the drive unit remains on-state under the action of the threshold voltage holding unit and drives the light-emitting device to emit light.

In the embodiment, specifically, the threshold voltage holding unit includes a capacitor, the anti-interference unit includes a third switch tube, the auxiliary gating unit includes a fourth switch tube, the charge-and-discharge control switch unit includes a fifth switch tube, the drive unit includes a first switch tube, and the switch unit includes a second switch tube. The detailed descriptions of the foregoing components may refer to the first embodiment and FIG. 3 and are not repeatedly described herein.

In the charging step 101, specifically, the second switch tube and the third switch tube are turned on under the control of a scan voltage provided by the scan signal line, the fourth switch tube is turned on under the control of a first control voltage provided by the first control line, the fifth switch tube is turned on under the control of a second control voltage provided by the second control line, and the data signal line provides a low level, so that the second power supply charges the capacitor. The scan voltage is at a high level, the first control voltage is at a high level, and the second control voltage is at a high level.

In the discharging step 102, specifically, the second switch tube and the third switch tube are turned on under the control of a scan voltage provided by the scan signal line, the fourth switch tube is turned off under the control of a first control voltage provided by the first control line, and the fifth switch tube is turned on under the control of a second control voltage provided by the second control line, so that the fifth switch tube, the first switch tube and the capacitor form a discharge loop. The scan voltage is at a high level, the first control voltage is at a low level, and the second control voltage is at a high level.

In the voltage-adjusting step 103, specifically, the second switch tube and the third switch tube are turned on under the control of a scan voltage provided by the scan signal line, the fourth switch tube is turned off under the control of a first control voltage provided by the first control line, the fifth switch tube is turned off under the control of a second control voltage provided by the second control line, the data signal line provides a high level, and voltage at the control electrode of the first switch tube is adjusted through the capacitor so as to turn on the first switch tube. The scan voltage is at a high level, the first control voltage is at a low level, and the second control voltage is at a low level.

In the driving step 104, specifically, the second switch tube and the third switch tube are turned off under the control of a scan voltage provided by the scan signal line, the fourth switch tube is turned on under the control of a first control voltage provided by the first control line, the fifth switch tube is turned off under the control of a second control voltage provided by the second control line, and the first switch tube remains on-state under the action of the capacitor and drives the light-emitting device to emit light. The scan voltage is at a low level, the first control voltage is at a high level, and the second control voltage is at a low level.

The pixel drive method provided by the embodiment may be implemented by the pixel drive circuit provided by the first embodiment, and the description of the pixel drive circuit may refer to the above first embodiment. In the pixel drive method provided by the embodiment, in the charging step, the switch unit is turned on, and the anti-interference unit, the auxiliary gating unit and the charge-and-discharge control switch unit control the second power supply and the data signal line to charge the threshold voltage holding unit; in the discharging step, the switch unit is turned on, and the charge-and-discharge control switch unit, the drive unit and the threshold voltage holding unit form a discharge loop; in the voltage-adjusting step, the switch unit is turned on, and the threshold voltage holding unit is charged through the data signal line to turn on the drive unit; and in the driving step, the switch unit is turned off, and the drive unit remains on-state under the action of the threshold voltage holding unit and drives the light-emitting device to emit light. The pixel drive method of the embodiment allows working current of the light-emitting device to be independent of the threshold voltage of the drive unit, so that the light-emitting brightness of the light-emitting device is uniform, and uniformity of the light-emitting brightness of the display device is thus improved.

It could be understood that the foregoing implementations are merely exemplary implementations for describing the principle of the present invention, but the present invention is not limited thereto. A person of ordinary skill in the art may make various modifications and improvements without departing from the spirit and essence of the present invention, and these modifications and improvements shall fall into the protection scope of the present invention.

1. A pixel drive circuit, comprising: a drive unit, a switch unit, a threshold voltage compensation module and a light-emitting device, wherein the threshold voltage compensation module is connected to a scan signal line, a first control line, a second control line, a second power supply and the switch unit, respectively, the light-emitting device is connected to the second power supply and the threshold voltage compensation module, respectively, the drive unit is connected to a first power supply and the threshold voltage compensation module, respectively, and the switch unit is connected to the scan signal line and a data signal line, respectively; and
the threshold voltage compensation module comprises a threshold voltage holding unit, an anti-interference unit, an auxiliary gating unit and a charge-and-discharge control switch unit.

2. The pixel drive circuit according to claim 1, wherein, the threshold voltage holding unit comprises a capacitor, the anti-interference unit comprises a third switch tube, the auxiliary gating unit comprises a fourth switch tube, and the charge-and-discharge control switch unit comprises a fifth switch tube;
a control electrode of the third switch tube is connected to the scan signal line, a first electrode of the third switch tube is connected to the second power supply and a first electrode of the light-emitting device, and a second electrode of the third switch tube is connected to a second electrode of the light-emitting device;
a control electrode of the fourth switch tube is connected to the first control line, a first electrode of the fourth switch tube is connected to the second electrode of the light-emitting device and the second electrode of the third switch tube, and a second electrode of the fourth switch tube is connected to a first electrode of the fifth switch tube and the drive unit;
a control electrode of the fifth switch tube is connected to the second control line, a second electrode of the fifth switch tube is connected to a second terminal of the capacitor and the drive unit; and
the first electrode of the light-emitting device is connected to the second power supply.

3. The pixel drive circuit according to claim 2, wherein, the drive unit comprises a first switch tube, and the switch unit comprises a second switch tube;
a control electrode of the first switch tube is connected to the second electrode of the fifth switch tube and the second terminal of the capacitor, a first electrode of the first switch tube is connected to the second electrode of the fourth switch tube and the first electrode of the fifth switch tube, and a second electrode of the first switch tube is connected to the first power supply; and
a control electrode of the second switch tube is connected to the scan signal line, a first electrode of the second switch tube is connected to the data signal line, and a second electrode of the second switch tube is connected to a first terminal of the capacitor.

4. The pixel drive circuit according to claim 1, wherein, working current I of the light-emitting device satisfies: I=K(VH−VL)2, where K is a process constant, VH is a high level of a data voltage provided by the data signal line, and VL is a low level of a data voltage provided by the data signal line.

5. The pixel drive circuit according to claim 3, wherein, the first switch tube, the second switch tube, the third switch tube, the fourth switch tube and the fifth switch tube are all thin film transistors.

6. An array substrate, comprising the pixel drive circuit according to claim 1.

7. A display device, comprising the array substrate according to claim 6.

8. A pixel drive method, which is based on the pixel drive circuit according to claim 1; the method comprising:
a charging step, in which the switch unit is turned on, the data signal line provides a low level, and the anti-interference unit, the auxiliary gating unit and the charge-and-discharge control switch unit control the second power supply to charge the threshold voltage holding unit;
a discharging step, in which the charge-and-discharge control switch unit, the drive unit and the threshold voltage holding unit form a discharge loop;
a voltage-adjusting step, in which the switch unit is turned on, the data signal line provides a high level, and voltage at the control electrode of the drive unit is adjusted through the threshold voltage holding unit to turn on the drive unit; and
a driving step, in which the switch unit is turned off, and the drive unit remains on-state under the action of the threshold voltage holding unit and drives the light-emitting device to emit light.

9. A pixel drive method, which is based on the pixel drive circuit according to claim 3; the method comprising:
a charging step, in which the switch unit is turned on, the data signal line provides a low level, and the anti-interference unit, the auxiliary gating unit and the charge-and-discharge control switch unit control the second power supply to charge the threshold voltage holding unit;
a discharging step, in which the charge-and-discharge control switch unit, the drive unit and the threshold voltage holding unit form a discharge loop;
a voltage-adjusting step, in which the switch unit is turned on, the data signal line provides a high level, and voltage at the control electrode of the drive unit is adjusted through the threshold voltage holding unit to turn on the drive unit; and
a driving step, in which the switch unit is turned off, and the drive unit remains on-state under the action of the threshold voltage holding unit and drives the light-emitting device to emit light; and wherein
the charging step further comprises: turning on the second switch tube and the third switch tube under the control of a scan voltage provided by the scan signal line, turning on the fourth switch tube under the control of a first control voltage provided by the first control line, turning on the fifth switch tube under the control of a second control voltage provided by the second control line, and supplying the data signal line with a low level, so that the second power supply charges the capacitor;
the discharging step further comprises: turning on the second switch tube and the third switch tube under the control of the scan voltage provided by the scan signal line, turning off the fourth switch tube under the control of the first control voltage provided by the first control line, and turning on the fifth switch tube under the control of the second control voltage provided by the second control line, so that the fifth switch tube, the first switch tube and the capacitor form a discharge loop;
the voltage-adjusting step further comprises: turning on the second switch tube and the third switch tube under the control of the scan voltage provided by the scan signal line, turning off the fourth switch tube under the control of the first control voltage provided by the first control line, turning off the fifth switch tube under the control of the second control voltage provided by the second control line, supplying the data signal line with a high level, and adjusting the voltage at the control electrode of the first switch tube through the capacitor to turn on the first switch tube; and
the driving step further comprises: turning off the second switch tube and the third switch tube under the control of a scan voltage provided by the scan signal line, turning on the fourth switch tube under the control of the first control voltage provided by the first control line, turning off the fifth switch tube under the control of the second control voltage provided by the second control line, and keeping the first switch tube in on-state state under the action of the capacitor and driving the light-emitting device to emit light.

10. The pixel drive method according to claim 9, wherein,
in the charging step, the scan voltage is at a high level, the first control voltage is at a high level, and the second control voltage is at a high level;
in the discharging step, the scan voltage is at a high level, the first control voltage is at a low level, and the second control voltage is at a high level;
in the voltage-adjusting step, the scan voltage is at a high level, the first control voltage is at a low level, and the second control voltage is at a low level; and
in the driving step, the scan voltage is at a low level, the first control voltage is at a high level, and the second control voltage is at a low level.

11. The array substrate according to claim 6, wherein, the threshold voltage holding unit comprises a capacitor, the anti-interference unit comprises a third switch tube, the auxiliary gating unit comprises a fourth switch tube, and the charge-and-discharge control switch unit comprises a fifth switch tube;
a control electrode of the third switch tube is connected to the scan signal line, a first electrode of the third switch tube is connected to the second power supply and a first electrode of the light-emitting device, and a second electrode of the third switch tube is connected to a second electrode of the light-emitting device;
a control electrode of the fourth switch tube is connected to the first control line, a first electrode of the fourth switch tube is connected to the second electrode of the light-emitting device and the second electrode of the third switch tube, and a second electrode of the fourth switch tube is connected to a first electrode of the fifth switch tube and the drive unit;
a control electrode of the fifth switch tube is connected to the second control line, a second electrode of the fifth switch tube is connected to a second terminal of the capacitor and the drive unit; and
the first electrode of the light-emitting device is connected to the second power supply.

12. The array substrate according to claim 11, wherein, the drive unit comprises a first switch tube, and the switch unit comprises a second switch tube;
a control electrode of the first switch tube is connected to the second electrode of the fifth switch tube and the second terminal of the capacitor, a first electrode of the first switch tube is connected to the second electrode of the fourth switch tube and the first electrode of the fifth switch tube, and a second electrode of the first switch tube is connected to the first power supply; and
a control electrode of the second switch tube is connected to the scan signal line, a first electrode of the second switch tube is connected to the data signal line, and a second electrode of the second switch tube is connected to a first terminal of the capacitor.

13. The array substrate according to claim 6, wherein, working current I of the light-emitting device satisfies: I=K(VH−VL)2, where K is a process constant, VH is a high level of a data voltage provided by the data signal line, and VL is a low level of a data voltage provided by the data signal line.

14. The array substrate according to claim 12, wherein, the first switch tube, the second switch tube, the third switch tube, the fourth switch tube and the fifth switch tube are all thin film transistors.

15. The display device according to claim 7, wherein, the threshold voltage holding unit comprises a capacitor, the anti-interference unit comprises a third switch tube, the auxiliary gating unit comprises a fourth switch tube, and the charge-and-discharge control switch unit comprises a fifth switch tube;
a control electrode of the third switch tube is connected to the scan signal line, a first electrode of the third switch tube is connected to the second power supply and a first electrode of the light-emitting device, and a second electrode of the third switch tube is connected to a second electrode of the light-emitting device;
a control electrode of the fourth switch tube is connected to the first control line, a first electrode of the fourth switch tube is connected to the second electrode of the light-emitting device and the second electrode of the third switch tube, and a second electrode of the fourth switch tube is connected to a first electrode of the fifth switch tube and the drive unit;
a control electrode of the fifth switch tube is connected to the second control line, a second electrode of the fifth switch tube is connected to a second terminal of the capacitor and the drive unit; and
the first electrode of the light-emitting device is connected to the second power supply.

16. The display device according to claim 15, wherein, the drive unit comprises a first switch tube, and the switch unit comprises a second switch tube;
a control electrode of the first switch tube is connected to the second electrode of the fifth switch tube and the second terminal of the capacitor, a first electrode of the first switch tube is connected to the second electrode of the fourth switch tube and the first electrode of the fifth switch tube, and a second electrode of the first switch tube is connected to the first power supply; and
a control electrode of the second switch tube is connected to the scan signal line, a first electrode of the second switch tube is connected to the data signal line, and a second electrode of the second switch tube is connected to a first terminal of the capacitor.

17. The display device according to claim 7, wherein, working current I of the light-emitting device satisfies: I=K(VH−VL)2, where K is a process constant, VH is a high level of a data voltage provided by the data signal line, and VL is a low level of a data voltage provided by the data signal line.

18. The display device according to claim 16, wherein, the first switch tube, the second switch tube, the third switch tube, the fourth switch tube and the fifth switch tube are all thin film transistors.
